(19) United States
(12) Patent Application Publication
(10) Pub. No.: US 2020/0186872 A1
(43) Pub. Date: Jun. 11, 2020

(54) METHOD OF SWITCHING CHANNELS AND INTELLIGENT TELEVISION

(71) Applicant: QINGDAO HISENSE ELECTRONICS CO., LTD., Qingdao (CN)

(72) Inventors: Xiaoming SHAO, Qingdao (CN); Laizhi ZHANG, Qingdao (CN); Zhaolong ZHU, Qingdao (CN)

(73) Assignee: QINGDAO HISENSE ELECTRONICS CO., LTD., Qingdao (CN)

(21) Appl. No.: 16/689,914

(22) Filed: Nov. 20, 2019

Related U.S. Application Data
(63) Continuation of application No. PCT/CN2019/115139, filed on Nov. 1, 2019.

(30) Foreign Application Priority Data
Dec. 7, 2018 (CN) 201811496358.2
Dec. 7, 2018 (CN) 201811497876.6

(51) Int. Cl. H04N 21/438; H04N 21/482; H04N 5/44; H04N 5/455; H04N 5/445; H04H 20/26

(52) U.S. Cl. CPC H04N 21/4384; H04N 21/482; H04N 5/4403; H04N 2005/44517; H04N 5/44513; H04H 20/26; H04N 2005/441; H04N 5/455

(57) ABSTRACT

A method of switching channels includes: while displaying a current channel, in response to receiving a first instruction for channel adjustment, displaying a first channel number on a user interface based on the first instruction; in response to receiving a plurality of consecutive second instructions for channel adjustment and wherein a time difference between two consecutive received instructions among the first instruction and the plurality of consecutive second instructions is less than or equal to a predetermined time period, determining an updated channel number by increasing or decreasing a value of the first channel number based on the plurality of consecutive second instructions without performing a channel switching operation; and in response to determining that the predetermined time period has passed after receiving a last instruction of the plurality of consecutive second instructions without receipt of another instruction for channel adjustment, switching the current channel to a second channel corresponding to the updated channel number.

### CROSS REFERENCE TO RELATED APPLICATIONS

This application is a continuation application of International Patent Application No. PCT/CN2019/115139, filed on, Nov. 1, 2019, which claims priority to Chinese Patent Application No. 201811496358.2 entitled “METHOD OF SWITCHING CHANNELS AND INTELLIGENT TELEVISION”, filed with the Chinese Patent Office on Dec. 7, 2018, and Chinese Patent Application No. 201811497876.6 entitled “METHOD OF SWITCHING CHANNELS AND INTELLIGENT TELEVISION”, filed with the Chinese Patent Office on Dec. 7, 2018, the entire contents of each of which are incorporated herein by reference.

### TECHNICAL FIELD

The present disclosure relates to television technology and in particular to a method of switching channels and an intelligent television.

### BACKGROUND

Channel switching is one of the most basic and common functions of a television. When switching channels, a user usually switches channels in a channel sequence by using, for example, a channel up button or a channel down button on a remote controller. A television chip performs one channel switching when the user sends an instruction for channel adjustment by, for example, the remote controller every time. Sometimes, the user performs continuous channel adjustment. In this case, the television chip caches all the instructions for channel adjustment sent by the user through, for example, the remote controller, so as to complete channel switching in sequence.

However, when the television chip performs channel switching, television (TV) signals are demodulated by a demodulator and channels are then switched according to program information carried in the TV signals. In this case, the TV chip performs one successful channel switching at a low processing speed, and thus cannot respond to the instruction for channel adjustment sent by the user quickly.

For example, the TV is switched to a next channel by the TV chip when one instruction for channel adjustment is triggered by using the remote controller, whereas an instruction for channel adjustment for switching to another next channel is triggered by using the remote controller when the TV has not been switched successfully. In this case, the operating speed of the TV becomes very slow and the TV even crashes. Especially, when the user sends instructions for channel adjustment continuously via the remote controller, a following phenomenon will occur: the TV is still switching channels even though the user stops operating the remote controller. As a result, the user cannot watch a desired channel in time and the user's experiences are affected.

It can be seen that the TV switches channels by the chip at a low speed at present. As a result, the TV is easily to be crashed when the user switches channels quickly. Therefore, the requirements of quickly switching channels cannot be satisfied.

### SUMMARY

According to a first aspect of embodiments of the present disclosure, a method of switching channels is provided. The method includes: receiving a first instruction for channel adjustment by the intelligent television while displaying a current channel on a display screen of the intelligent television; in response to receiving the first instruction for channel adjustment, displaying a first channel number based on the first instruction for channel adjustment on a user interface displayed by the display screen of the intelligent television; receiving a plurality of consecutive second instructions for channel adjustment by the intelligent television; determining that a time difference between two consecutive received instructions among the first instruction for channel adjustment and the plurality of consecutive second instructions for channel adjustment is less than or equal to a predetermined time period; in response to receiving the plurality of consecutive second instructions for channel adjustment and in response to determining that the time difference between two consecutive received instructions among the first instruction for channel adjustment and the plurality of consecutive second instructions for channel adjustment is less than or equal to the predetermined time period, determining an updated channel number by increasing or decreasing a value of the first channel number based on the plurality of consecutive second instructions for channel adjustment without performing a channel switching operation; determining that the predetermined time period has passed after receiving a last instruction of the plurality of consecutive second instructions for channel adjustment without receipt of another instruction for channel adjustment; and in response to determining that the predetermined time period has passed after receiving a last instruction of the plurality of consecutive second instructions for channel adjustment without receipt of another instruction for channel adjustment, switching the current channel to a second channel corresponding to a value of the updated channel number.

According to a second aspect of embodiments of the present disclosure, an intelligent TV is provided. The intelligent TV includes a display screen, a memory and a processor. The memory is configured to store computer instructions. The processor is configured to execute the computer instructions to cause the intelligent television to: receive a first instruction for channel adjustment while displaying a current channel on the display screen; in response to receiving the first instruction for channel adjustment, display a first channel number based on the first instruction for channel adjustment on a user interface displayed on the display screen; receive a plurality of consecutive second instructions for channel adjustment; determine that a time difference between two consecutive received instructions among the first instruction and the plurality of consecutive second instructions is less than or equal to a predetermined time period; in response to receiving the plurality of consecutive second instructions and in response to determining that the time difference between two consecutive received instructions among the first instruction and the plurality of consecutive second instructions is less than or equal to the predetermined time period, determine an updated channel number by increasing or decreasing a value of the first channel number based on the plurality of consecutive second instructions for channel adjustment without performing a channel switching operation; determine that the predetermined time period has passed after receiving a last instruction of the plurality of consecutive second instructions for channel adjustment without receipt of another instruction for channel adjustment; and in response to determining that the predetermined time period has passed after receiving a last instruction of the plurality of consecutive second instructions for channel adjustment without receipt of another instruction for channel adjustment, switch the current channel to a second channel corresponding to a value of the updated channel number.

According to a third aspect of embodiments of the present disclosure, a computer-readable non-volatile storage medium storing computer instructions is provided. The computer instructions are executed by a processor to: receive a first instruction for channel adjustment while displaying a current channel on an intelligent television; in response to receiving the first instruction for channel adjustment, display a first channel number based on the first instruction for channel adjustment on a user interface displayed by a display screen of the intelligent television; receive a plurality of consecutive second instructions for channel adjustment; determine that a time difference between two consecutive received instructions among the first instruction and the plurality of consecutive second instructions is less than or equal to a predetermined time period; in response to receiving the plurality of consecutive second instructions and in response to determining that the time difference between two consecutive received instructions among the first instruction and the plurality of consecutive second instructions is less than or equal to the predetermined time period, determine an updated channel number by increasing or decreasing a value of the first channel number based on the plurality of consecutive second instructions for channel adjustment without performing a channel switching operation; determine that the predetermined time period has passed after receiving a last instruction of the plurality of consecutive second instructions for channel adjustment without receipt of another instruction for channel adjustment; and in response to determining that the predetermined time period has passed after receiving a last instruction of the plurality of consecutive second instructions for channel adjustment without receipt of another instruction for channel adjustment, switch the current channel to a second channel corresponding to a value of the updated channel number.

### BRIEF DESCRIPTION OF THE DRAWINGS

To describe the embodiments of present disclosure more clearly, accompanying drawings required for descriptions of embodiments will be briefly introduced below. The drawings described below are merely some examples of the present disclosure. Those skilled in the art may obtain other drawings based on these drawings without paying creative work.

FIG. 1 is a schematic diagram illustrating a method of switching channels according to some embodiments of the present disclosure.

FIG. 2 is a schematic diagram illustrating a state in which a channel adjustment button of a remote control device is not pressed according to some embodiments of the present disclosure.

FIG. 3 is a schematic diagram illustrating a state in which a channel adjustment button of a remote control device is pressed according to some embodiments of the present disclosure.

FIG. 4 is a schematic diagram illustrating another state in which a channel adjustment button of a remote control device is pressed according to some embodiments of the present disclosure.

FIG. 5 is a schematic diagram illustrating a user interface in a method of switching channels according to some embodiments of the present disclosure.

FIG. 6 is a schematic diagram illustrating a first preset image according to some embodiments of the present disclosure.

FIG. 7 is schematic diagram illustrating a second preset image according to some embodiments of the present disclosure.

FIG. 8 is schematic diagram illustrating a third preset image according to some embodiments of the present disclosure.

FIG. 9A is schematic diagram illustrating a change process of a user interface in a method of switching channels according to some embodiments of the present disclosure.

FIG. 9B is a schematic diagram illustrating a change process of a user interface in a method of switching channels according to some embodiments of the present disclosure.

FIG. 9C is a schematic diagram illustrating a change process of a user interface in a method of switching channels according to some embodiments of the present disclosure.

FIG. 9D is a schematic diagram illustrating a change process of a user interface in a method of switching channels according to some embodiments of the present disclosure.

FIG. 10A is a schematic diagram illustrating another change process of a user interface in the method of switching channels according to some embodiments of the present disclosure.

FIG. 10B is a schematic diagram illustrating another change process of a user interface in the method of switching channels according to some embodiments of the present disclosure.

FIG. 10C is a schematic diagram illustrating another change process of a user interface in the method of switching channels according to some embodiments of the present disclosure.

FIG. 10D is a schematic diagram illustrating another change process of a user interface in the method of switching channels according to some embodiments of the present disclosure.

FIG. 10E is a schematic diagram illustrating another change process of a user interface in the method of switching channels according to some embodiments of the present disclosure.

FIG. 11 is a time sequence diagram of triggering instructions for channel adjustment when a channel adjustment button is long-pressed according to some embodiments of the present disclosure.

FIG. 12 is a schematic diagram of triggering quick channel switching by long-pressing a channel adjustment button according to some embodiments of the present disclosure.

FIG. 13 is another schematic diagram of triggering quick channel switching by long-pressing a channel adjustment button according to some embodiments of the present disclosure.

FIG. 14 is a time sequence diagram of triggering instructions for channel adjustment by click-pressing quickly and continuously a channel adjustment button according to some embodiments of the present disclosure.

FIG. 15 is another time sequence diagram of triggering instructions for channel adjustment by click-pressing quickly and continuously a channel adjustment button according to some embodiments of the present disclosure.

FIG. 16 is yet another time sequence diagram of triggering instructions for channel adjustment by click-pressing quickly and continuously a channel adjustment button according to some embodiments of the present disclosure.

FIG. 17 is a schematic diagram of triggering quick channel switching by click-pressing quickly and continuously a channel adjustment button according to some embodiments of the present disclosure.

FIG. 18 is another schematic diagram of triggering quick channel switching by click-pressing quickly and continuously a channel adjustment button according to some embodiments of the present disclosure.

FIG. 19 is a schematic diagram illustrating a structure of an intelligent television according to some embodiments of the present disclosure.

FIG. 20 is another schematic diagram illustrating a structure of the intelligent television according to some embodiments of the present disclosure.

FIG. 21 is yet another schematic diagram illustrating a structure of the intelligent television according to some embodiments of the present disclosure.

### DETAILED DESCRIPTION OF THE EMBODIMENTS

To make the objects, embodiments and advantages of the present disclosure clearer, detailed descriptions will be made further for the present disclosure in combination with the accompanying drawings. The described embodiments are merely some embodiments of the present disclosure rather than all embodiments. Based on these embodiments of the present disclosure, other embodiments that, for example, may be obtained by those skilled in the art without paying creative work, shall all fall within the protection scope of the present disclosure.

Taking an intelligent television (TV) controlled with a remote control as an example, the embodiments of the present disclosure is further discussed with reference to the accompanying drawings.

When a TV chip performs channel switching, a demodulation process of TV signals is the most time-consuming part during the entire channel switching process. For example, the TV chip usually takes more than 200 ms to perform one channel switching.

Generally, the demodulation process is performed as follows: when receiving an instruction for channel adjustment from a remote control device, the TV determines whether two adjacent channels are in a same frequency band; if the two adjacent channels are in a same frequency band, channel switching is directly performed and time for the channel switching is about 1000 ms in this case; if the two adjacent channels are not in the same frequency band, a tuning operation is performed by a tuner to a corresponding frequency band and then channel switching is performed. In this case, the time for the channel switching is greater than 2000 ms. In this process, if a particular channel is a scrambled channel, the TV chip has to de-scrambling the scrambled channel first and then plays the particular channel.

In this case, when the TV receives instructions for channel adjustment continuously within a short time, if the TV switches to a next channel by the TV chip each time, an instruction for channel adjustment for switching to a next channel will further be triggered before the TV chip switches a current channel of the TV successfully. With the repeated operations, the operating speed of the TV becomes very low and the TV even crashes.

Explanations for a few terms are given below. It is noted that these explanations are not limitative, and only for illustrative embodiments.

Term “and/or” describes a relationship of associated objects and may represent three scenarios. For example, A, B, or A and B. The character “/” usually refers to an “or” relationship of the associated objects.

The term “intelligent TV channel switching interface” in the embodiments of the present disclosure is also referred to as “channel switching interface of the chip”.

As shown in FIG. 1, a method of switching channels according to some embodiments of the present disclosure is applied to an intelligent TV. The method specifically includes the following steps 10 to 12.

At step 10, while displaying a current channel on a display screen of the intelligent TV, in response to receiving a first instruction for channel adjustment, a first channel number updated based on the first instruction from the current channel is displayed on a user interface displayed by the display screen of the intelligent TV.

At step 11, in response to receiving a plurality of second instructions for channel adjustment following the first instruction for channel adjustment and determining that a time interval between two consecutive received instructions among the first instruction for channel adjustment and the plurality of second instructions for channel adjustment is less than or equal to a predetermined first time period, an updated channel number by increasing or decreasing a value of the first channel number based on the plurality of second instructions for channel adjustment is determined without performing a channel switching operation.

At step 12, in response to determining that the predetermined time period has passed after receiving a last instruction of the plurality of consecutive second instructions for channel adjustment without receipt of another instruction for channel adjustment, a current channel is switched to a second channel corresponding to a value of the updated channel number.

According to the above process, when the first instruction for channel adjustment is received from a user, a first channel number updated from the current channel based on the first instruction for channel adjustment is displayed on the user interface presented on the display screen of the intelligent TV. If a plurality of the second instructions for channel adjustment are received following the first instruction for channel adjustment and a time interval between any adjacent two instructions of the first instruction for channel adjustment and the plurality of the second instructions is not greater than the predetermined first time period, the updated channel number is obtained by increasing or decreasing the first channel number based on the plurality of second instructions for channel adjustment without performing channel switching operation, that is to say, without switching the content of the current channel to content of the updated channel. Upon no second adjustment instruction being received within the predetermined first time period, an interface for intelligent TV channel switching is invoked to perform channel switching. The intelligent TV channel switching interface is not invoked to perform channel switching during a process of adjusting the displayed channel number. In this case, a user can see a process that the intelligent TV responds to the instructions for channel adjustment in time, and the intelligent TV channel switching interface is not frequently invoked to perform channel switching. In this way, the communications of the intelligent TV middleware are reduced and the demodulations for channel switching through the intelligent TV channel switching interface are reduced as well. Therefore, the channel switching speed and stability of performing quick channel switching by the intelligent TV is improved, thereby avoiding the problems that the intelligent TV responds slowly and crashes easily during quick channel switching.

It is noted that, in some embodiments of the present disclosure, the first instruction for channel adjustment and the second instructions for channel adjustment are triggered by a first event of a channel adjustment button of a remote control device. For example, the channel adjustment button is a channel up button or a channel down button, and the first event is a channel up event or a channel down event.

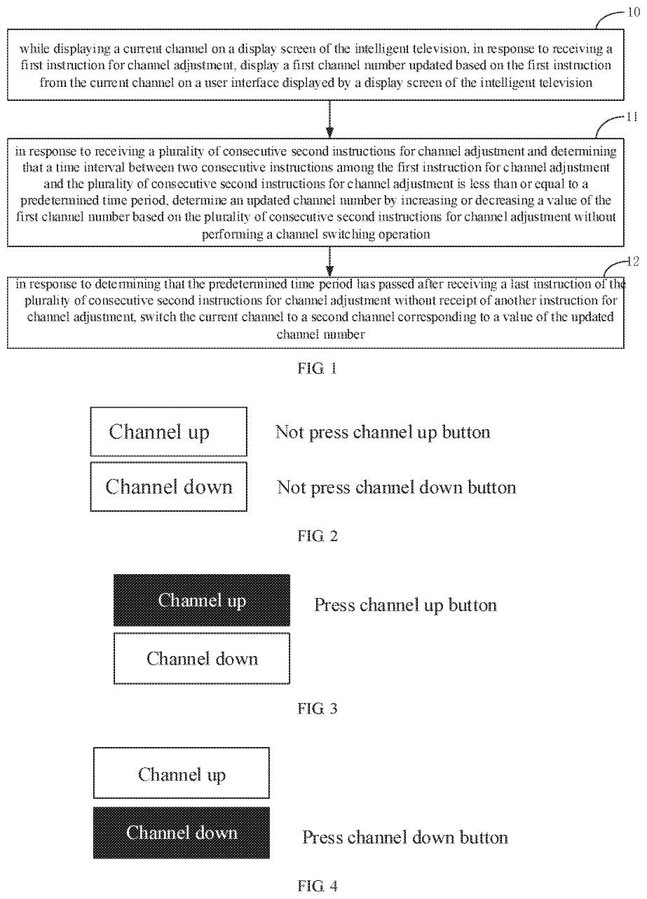

As shown in FIG. 2, the remote control device is in a normal state, i.e., in a state where the user does not operate the channel buttons of the remote control device.

When the channel up button is pressed, the remote control device sends a DOWN or pressed message of the channel up button to the intelligent TV. When the channel up button is released, the remote control device sends an UP or release message of the channel up button to the intelligent TV. FIG. 3 illustrates a state where the channel up button of the remote control device is pressed.

Correspondingly, when the channel up button is pressed, a DOWN or pressed event of the channel up button triggers the remote control device to send an instruction for channel adjustment for adjusting channel up to the intelligent TV; and when the channel up button is released, an UP event or a release event of the channel up button triggers the remote control device to send a released instruction of the channel up button to the intelligent TV.

When the channel down button is pressed, the remote control device sends a DOWN or pressed message of the channel down button to the intelligent TV; and when the channel down button is released, the remote control device sends an UP or release message of the channel down button to the intelligent TV. FIG. 4 illustrates a state where a channel down button of a remote control device is pressed.

Correspondingly, when the channel down button is pressed, a DOWN or pressed event of the channel down button triggers the remote control device to send an instruction for channel adjustment for adjusting channel down to the intelligent TV; and when the channel down button is released, an UP or release event of the channel down button triggers the remote control device to send an released instruction of the channel down button to the intelligent TV.

Further, when the channel adjustment button is pressed, the remote control device sends the DOWN message of the channel adjustment button to the intelligent TV. If the channel adjustment button is not released for long, the remote control device sends the DOWN message carrying a particular field (for example repeat filed) to the intelligent TV at a particular time interval repeatedly. The remote control device sends the UP message to the intelligent TV until the channel adjustment button is released. Correspondingly, when the above channel adjustment button is long-pressed, the remote control device sends the instruction for channel adjusting to the intelligent TV at the particular time interval repeatedly until the channel adjustment button is released.

When the channel adjustment button is pressed, the remote control device sends the DOWN message of the channel adjustment button to the intelligent TV. If the channel adjustment button is pressed again within a particular time period after the channel adjustment button is released, the remote control device sends the DOWN message to the intelligent TV again. When the channel adjustment button is released again, the remote control device sends the UP message to the intelligent TV again. This process is repeated until the channel adjustment button is not re-pressed within the particular time period. Correspondingly, when the channel adjustment button is click-pressed quickly and continuously as mentioned above, the remote control device sends the instruction for channel adjustment to the intelligent TV continuously until the channel adjustment button is not pressed within the particular time period.

Illustratively, a specific process of performing channel switching is as follows.

After the first instruction for channel adjustment sent from a user through the remote control device is received for the first time, a first channel number based on the first instruction for channel adjustment obtained by increasing or decreasing the current channel is displayed in an infobar (task bar), and the current channel is switched through the channel switching interface of the chip to a first channel targeted by the first instruction for channel adjustment received for the first time. For example, the TV plays a channel 1 currently, and the TV displays a channel number 2 (i.e. the first channel number) when receiving the instruction for channel adjustment of the channel up button, and switches the current channel to the channel 2 (i.e. the first channel) by invoking the channel switching interface of the chip at the same time.

After displaying the first channel number based on the first instruction for channel adjustment received for the first time, the intelligent TV continues monitoring the UP message and the DOWN message of the channel adjustment button.

If the TV does not receive the second instruction for channel adjustment subsequently after displaying the first channel number, the TV continues playing the first channel based on the first instruction for channel adjustment received for the first time.

If the intelligent TV receives the second instructions for channel adjustment subsequently after displaying the first channel number based on the first instruction for channel adjustment, and the time interval between any two adjacent instructions of the first instruction for channel adjustment and a plurality of the second adjustment instructions is not greater than the predetermined first time period, the intelligent TV starts a quick channel switching process to increase or decrease the displayed channel number based on the received second instructions for channel adjustment. When it is determined that the second channel adjustment instruction is not received again, the current channel is switched to a channel corresponding to the updated channel number by invoking the intelligent TV channel switching interface.

Specifically, the finally updated channel number is transmitted to a data processing layer through a presentation layer of the intelligent TV, and the current channel is switched to a channel corresponding to the finally updated channel number by invoking the intelligent TV channel switching interface.

It is noted that the intelligent TV channel switching interface usually completes channel switching at second level, and the quick instruction for channel adjustment conforming to operation habits of the user is completed in the millisecond level. Therefore, in some embodiments of the present disclosure, the predetermined first time period is set at the millisecond level and usually less than a time period of performing one channel switching by the intelligent TV channel switching interface.

As described above, when the TV performs channel switching through the channel switching interface of the chip, the channel switching within a frequency points usually takes about 1s, and the channel switching between two different frequency points usually takes more than 2s.

Further, after displaying the first channel number updated based on the first instruction for channel adjustment, if the intelligent TV continues receiving the second instructions for channel adjustment and the presentation layer of the intelligent TV determines that the time interval between any two adjacent instructions of the first instruction for channel adjustment and the second instructions for channel adjustment is not greater than the predetermined first time period, the presentation layer of the intelligent TV increases or decreases the displayed channel number, and the intelligent TV channel switching interface for channel switching will no longer be invoked in the process of adjusting the displayed channel number. When no instruction for channel adjustment is received again, the current channel is switched to a channel corresponding to the updated channel number through the intelligent TV channel switching interface at the processing layer. In this case, the communications between the presentation layer and the processing layer of the intelligent TV are reduced, and the demodulations for performing channel switching through the intelligent TV channel switching interface are reduced.

The presentation layer of the intelligent TV has the quick channel switching process. After being triggered to enter the quick channel switching process, the intelligent TV shields information output from its channel switching interface of the chip. For example, after receiving an instruction for channel adjustment during a display process, the intelligent TV switches a current channel to a channel based on this instruction for channel adjustment by invoking the intelligent TV channel switching interface. And the processing layer of the intelligent TV reports the information of the channel based on this received instruction for channel adjustment when the intelligent TV completes the switching.

The intelligent TV shields the above information. The information includes a channel number, resolution information and program information of the channel based on this received instruction for channel adjustment, and whether the optical fiber or Dolby and the like is supported.

There are many manners to trigger the intelligent TV to perform the quick channel switching process, which will be described below by way of examples.

In the first trigger manner, the instruction for channel adjustment performed by long-pressing the channel adjustment button triggers the intelligent TV to execute the quick channel switching process. After the first channel number based on the first instruction for channel adjustment is displayed, if the second instructions for channel adjustment are received subsequently, the intelligent TV determines that the instructions for channel adjustment are triggered by the user by long-pressing the channel adjustment button on the remote controller, in response to not receiving UP event, i.e. the second event, of the channel adjustment button between any two adjacent instructions of the first instruction for channel adjustment and the second instructions for channel adjustment. Or, in response to determining that the first instruction and the plurality of consecutive second instructions were received prior to receiving any second event of the channel adjustment button, the intelligent TV determines that the plurality of consecutive second instructions for channel adjustment were triggered by a user long-pressing the channel adjustment button.

The DOWN message, i.e. the DOWN event of the channel adjustment button is triggered when the channel adjustment button of the remote control device is pressed every time. The UP message i.e. the UP event of the channel adjustment button is triggered when the channel adjustment button is released. If the channel adjustment button is not released for long, the remote control device sends the DOWN message repeatedly at a particular time interval, and the DOWN messages except for the DOWN message received for the first time respectively carry the repeat field. For example, when the channel adjustment button is long-pressed, the DOWN message is sent repeatedly at the time interval of 200 ms. FIG. 11 is a time sequence diagram of triggering an instruction for channel adjustment when a channel adjustment button is long-pressed. As shown in FIG. 11, when the channel adjustment button is long-pressed, the instruction for channel adjustment is sent repeatedly at the time interval of 200 ms.

When receiving, for the first time, the first instruction for channel adjustment triggered by the DOWN event of the channel adjustment button, the intelligent TV displays the first channel number based on the first instruction for channel adjustment received for the first time and performs channel switching by invoking the intelligent TV channel switching interface at the same time. If no UP event of the channel adjustment button is received and the second instructions for channel adjustment triggered by the DOWN event of the channel adjustment button are received again within a time interval which is no greater than the predetermined first time period, the quick channel switching process is started, and it is determined that the quick channel switching process is started by long-pressing the channel adjustment button by the user.

After the intelligent TV starts the quick channel switching process, the intelligent TV performs at least three operations as follows.

In an operation, information output from the intelligent TV channel switching interface is shielded.

The information output from the intelligent TV channel switching interface is no longer updated. For example, the information includes channel number information, resolution information and program information of a channel after successful switching, whether the optical fiber or Dolby and the like is supported, after the TV chip successfully performs channel switching.

In another operation, channel switching that is performed by invoking the intelligent TV channel switching interface is suspended.

After starting the quick channel switching process, the intelligent TV increases or decreases the displayed channel number based on a plurality of received second instructions for channel adjustment without performing actual channel switching operation, that is, without performing channel switching by invoking the intelligent TV channel switching interface.

In yet another operation, the displayed channel number is updated based on the plurality of second instructions for channel adjustment.

After starting the quick channel switching process, the intelligent TV increases or decreases the displayed channel number based on instructions for channel adjustment received subsequently.

For example, the intelligent TV increases the currently displayed channel number by one if receiving the DOWN message carrying the repeat field from the channel up button, which is repeated until the intelligent TV receives the UP message from the channel up button.

Alternatively, the intelligent TV decreases the currently displayed channel number by one if receiving the DOWN message carrying the repeat field from the channel down button, which is repeated until the intelligent TV receives the UP message from the channel down button.

If receiving the UP message of the channel adjustment button, the intelligent TV stops adjusting the displayed channel number, transmits the currently displayed channel number to the processing layer, and switches the current channel to a second channel corresponding to the updated channel number by invoking the intelligent TV channel switching interface. At the same time, the intelligent TV resumes executing a corresponding operation that the information of the second channel is output from the intelligent TV channel switching interface.

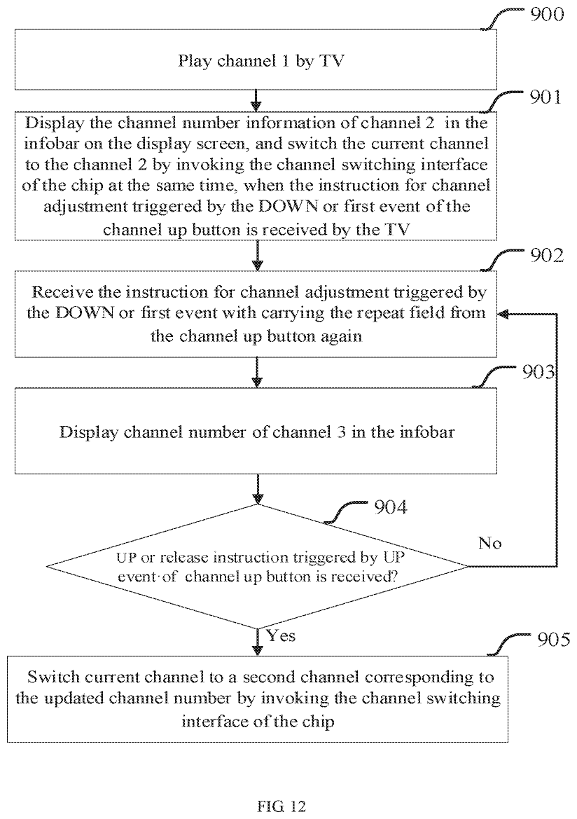

FIG. 12 is a schematic diagram of performing quick channel switching by long-pressing the channel adjustment button according to some embodiments of the present disclosure. The following steps 900 to 905 are shown.

At step 900, a TV plays a channel 1.

As shown in FIG. 5, the display screen of the TV is playing program content of the channel 1 currently. The channel information such as a channel name, a channel number and the like of the channel 1 is displayed in the infobar (task bar) on a top portion of the display screen.

At step 901, when the instruction for channel adjustment triggered by the DOWN or first event of the channel up button is received by the TV, the channel number information of channel 2 is displayed in the infobar on the display screen, and the current channel is switched to the channel 2 by invoking the channel switching interface of the chip at the same time.

At step 902, the TV receives the instruction for channel adjustment triggered by the DOWN or first event with a repeat field from the channel up button again.

At step 903, a preset image is displayed on the display screen and the channel number information of channel 3 is displayed in the infobar at the same time.

At step 904, it is determined whether an UP or release instruction triggered by the UP or first event of the channel up button is received. If an UP or release instruction triggered by the UP or first event of the channel up button is received, step 905 is performed, and otherwise, step 902 is performed.

At step 905, the current channel is switched to a second channel corresponding to the updated channel number in the infobar by invoking the channel switching interface of the chip.

It is noted that after step 902, i.e., after the TV receives the instruction for channel adjustment triggered by the first event with the DOWN message carrying the repeat field from the channel up button, the step 903 is performed, and at the same time, the TV shields information output from the channel switching interface of the chip and the channel switching interface of the chip will no longer be invoked to perform channel switching.

After step 904, i.e., after it is determined that the UP or release instruction triggered by the UP or first event of the channel up button is received, step 905 is performed, and at the same time, the shielding of the information output from the channel switching interface of the chip is cancelled.

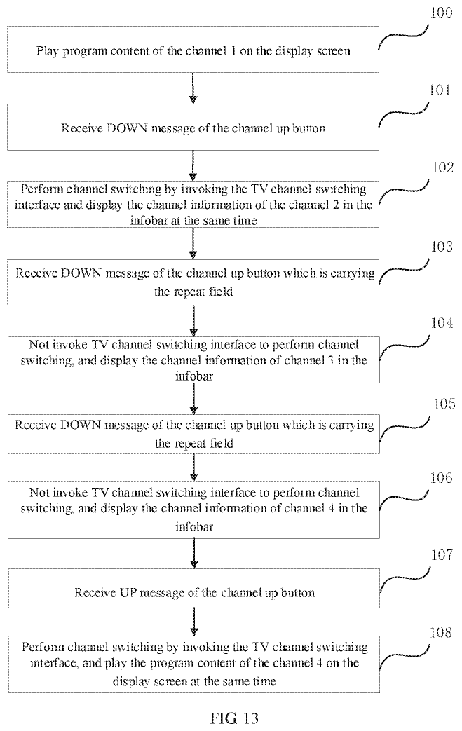

FIG. 13 is another schematic diagram of performing quick channel switching by long-pressing a channel adjustment button according to some embodiments of the present disclosure. The following steps 100 to 108 are shown. In order to adapt for user's habits, the displayed preset image may be an image of a current channel displayed by the intelligent TV, i.e. an image before starting channel adjustment. For example, a final frame of image of the channel 1 displayed immediately after the startup of the TV.

At step 100, program content of the channel 1 is played on the display screen. Herein, the user interface is as shown in FIG. 5.

At step 101, the DOWN message of the channel up button is received from the remote control device.

At step 102, channel switching is performed by invoking the TV channel switching interface, and the channel information of the channel 2 is displayed in the infobar of the display screen at the same time.

Specifically, channel information of a next channel which is adjacent to the previous channel, is obtained from an existing channel list. For example, the channel information such as a name, the channel number and the like of the channel 2, which is the next channel of previous channel 1, is displayed in the infobar, so that the user may see from the infobar that the TV already is triggered to perform channel switching.

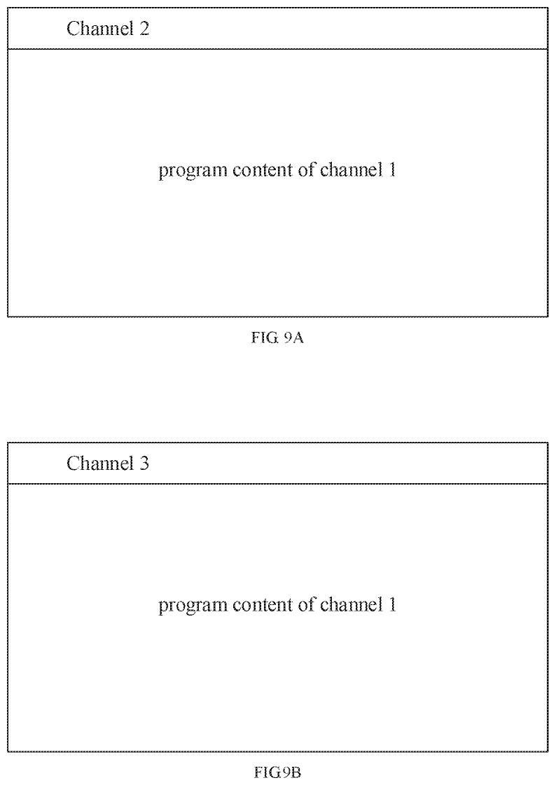

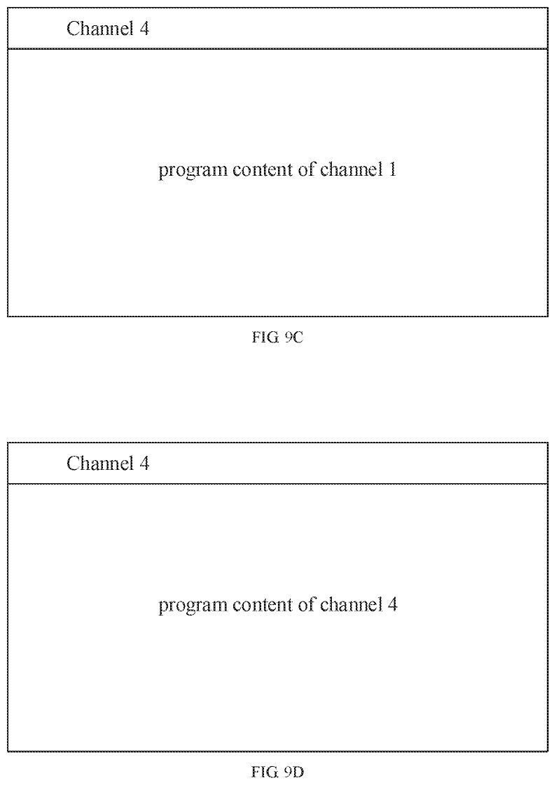

At the same time, the DOWN message of the channel up button triggers the instruction for channel adjustment. In this case, a process of switching the channel 1 to the channel 2 is performed by invoking the channel switching interface of the chip, i.e. the TV channel switching interface. Because it takes a long time to switch to channel 2 by invoking the TV chip, the TV chip will not successfully perform channel switching within a short time, and the program content of the channel 1 is still displayed on the display screen in some embodiments. Herein, the user interface is as shown in FIG. 9A. In FIG. 9A, in order to quickly respond to the instruction for channel adjustment sent from the user through the remote control device, and in order to notify the user that the TV already starts the process of switching to the channel 2 in time, channel information such as channel name, and the channel number and the like of a next channel i.e. the channel 2, to which the TV channel is to be switched based on the instruction for channel adjustment, is displayed in the infobar at the top of the display screen.

At step 103, the DOWN message of the channel up button which is carrying the repeat field is received from the remote control device.

At step 104, the TV channel switching interface is no longer invoked to perform channel switching, and the channel information of channel 3 is displayed in the infobar of the display screen.

When the DOWN message carrying the repeat field is received, which means the user intends to perform continuous channel switching within a short time, the quick channel switching process is triggered by long-pressing the channel adjustment button.

Specifically, channel information of a next channel with a larger channel number, which is adjacent to the previous channel number, is obtained from the existing channel list. For example, the channel information such as channel name, the channel number and the like of the channel 3 with the larger channel number is displayed in the infobar, so that the user may see that the TV already is triggered to perform channel switching.

At the same time, all messages including message of switching the channel 1 to the channel 2 successfully, which are reported by the TV channel switching interface, are shielded to reduce the communications of the TV middleware.

Further, the TV channel switching interface is no longer invoked to perform channel switching, and the message of successfully switching the channel 1 to the channel 2, which is reported by the TV channel switching interface, is shielded. Thus, the program content of the channel 1 is still displayed on the display screen. Herein, the user interface is as shown in FIG. 9B. As shown in FIG. 9B, in order to quickly respond to the instruction for channel adjustment sent from the user through the remote control device, and in order to notify the user that the TV already starts the process of switching to the channel 3 in time, channel information such as channel name, the channel number and the like of a next channel i.e. the channel 3, to which the TV channel is to be switched based on the instruction for channel adjustment, is displayed in the infobar at the top of the display screen.

At step 105, the DOWN message of the channel up button which is carrying the repeat field is received from the remote control device.

At step 106, the TV channel switching interface is no longer invoked to perform channel switching, and the channel information of channel 4 is displayed in the infobar of the display screen.

As at step 104, channel information of a next channel with a larger channel number, which is adjacent to the previous channel, is obtained from an existing channel list. For example, the channel information such as channel name, the channel number and the like of the channel 4 with the larger channel number is displayed in the infobar, so that the user may see that the TV already is triggered to perform channel switching.

Further, the TV channel switching interface is no longer invoked to perform channel switching, and the message of successfully switching the channel 1 to the channel 2, which is reported by the TV channel switching interface, is shielded. Thus, the program content of the channel 1 is still displayed on the display screen. Herein, the user interface is as shown in FIG. 9C. As shown in FIG. 9C, in order to quickly respond to the instruction for channel adjustment sent from the user through the remote control device, and in order to notify the user that the TV already starts the process of switching to the channel 4 in time, channel information such as channel name, the channel number and the like of a next channel i.e. the channel 4, to which the TV channel is to be switched based on instruction for channel adjustment, is displayed in the infobar at the top of the display screen.

It is noted that if the DOWN message carrying the repeat field is received again from the channel up button of the remote control device, step 104 is repeated. At the same time, for example, it is displayed that the channel number is updated from channel 3 to channel 4.

At step 107, the UP message of the channel up button is received from the remote control device.

At step 108, channel switching is performed by invoking the TV channel switching interface, and the program content of the channel 4 is played on the display screen at the same time.

The UP message of the channel up button is received, which means no more instructions for channel adjustment. In this case, the quick channel switching process is stopped, and the shielding of information that is reported by the TV channel switching interface is cancelled at the same time. The channel information finally displayed in the infobar is transmitted to the TV chip, that is, the TV channel is switched to a channel corresponding to the channel information finally displayed in the infobar by invoking the TV channel switching interface.

For example, when the TV channel is switched to the channel 4 finally displayed in the infobar by invoking the TV channel switching interface, the program content of the channel 4 is played on the display screen. Herein, the user interface is as shown in FIG. 9D. As shown in FIG. 9D, channel switching is performed by invoking the TV chip, and the TV channel is switched to the channel corresponding to the channel information finally displayed in the infobar. For example, the program content of the channel 4 in the infobar as shown in FIG. 9C is played on the display screen, and the channel information such as channel name, the channel number and the like of the channel 4 is displayed in the infobar. In this way, the TV can display, in time, a channel that the user eventually wants to watch, when the user no longer operates the remote control device, thereby avoiding a phenomenon that the TV is still switching channels or lagging.

In the second trigger manner, the instructions for channel adjustment performed by quickly and continuously click-pressing the channel adjustment button cause the intelligent TV to enter the quick channel switching process.

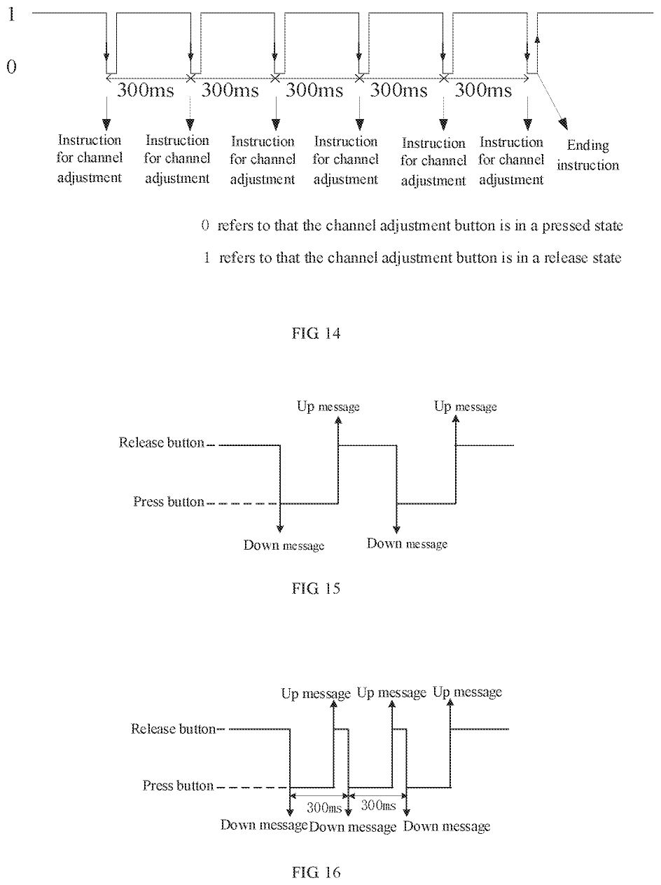

The DOWN message, i.e. the DOWN event of the channel adjustment button, is triggered, when the channel adjustment button of the remote control device is pressed every time. When the channel adjustment button is released, the UP message, i.e. the UP event of the channel adjustment button, is triggered. If receiving the UP event, i.e. a second event, of the channel adjustment button between two adjacent instructions for channel adjustment, the intelligent TV determines that the instruction for channel adjustment is performed by the user through quickly and continuously click-pressing the channel adjustment button. Or, in response to receiving the second event of the channel adjustment button between any two consecutive received instructions of the first instruction and the plurality of consecutive second instructions, the intelligent TV determines that the plurality of consecutive second instructions for channel adjustment were triggered by a user click-pressing the channel adjustment button. FIG. 14 is a time sequence diagram illustrating an instruction for channel adjustment triggered by quickly and continuously click-pressing the channel adjustment button. As shown in FIG. 14, the time interval of receiving the instructions for channel adjustment triggered by the DOWN message of the channel adjustment button is 300 ms. As shown in FIG. 16, the time interval, which is between the DOWN messages of the channel adjustment button received by the TV for two successive times when a user click-presses the channel adjustment button two times quickly, is 300 ms, which is less than the time interval (for example, 500 ms) that is between the DOWN messages of the channel adjustment button received by the TV for two successive times when the user presses the channel adjustment button for two successive times as shown in FIG. 15. Illustratively, the time intervals between the adjacent instructions for channel adjustment as shown in FIG. 11, and FIGS. 14-16 are not greater than the predetermined first time period.

When the first instruction for channel adjustment is received for the first time, the first channel number is displayed. If a second instruction for channel adjustment is received subsequently and the time interval between the second instruction for channel adjustment and the first instruction for channel adjustment received for the first time is not greater than the predetermined first time period, the intelligent TV is triggered to perform the quick channel switching process.

The intelligent TV is triggered to enter the quick channel switching process in two manners of quickly and continuously click-pressing the channel adjustment button, which will be discussed respectively below.

In the first click-pressing manner, the intelligent TV is triggered to enter the quick channel switching process by sending the same instructions for channel adjustment by quickly and continuously click-pressing the same channel adjustment button.

For example, when the channel up button or the channel down button is clicked continuously two times, the intelligent TV receives two same instructions for channel adjustment with the time interval no greater than the predetermined first time period, so that the TV enters the quick channel switching process.

In the second click-pressing manner, the intelligent TV is triggered to enter the quick channel switching process by sending different instructions for channel adjustment by click-pressing quickly and continuously different channel adjustment buttons.

For example, when the user click-presses the channel up button after click-pressing the channel down button, the intelligent TV receives two different instructions for channel adjustment with the time interval no greater than the predetermined first time period, so that the intelligent TV enters the quick channel switching process.

In some embodiments of the present disclosure, after the intelligent TV is triggered to enter the quick channel switching process via the DOWN events triggered by the user by click-pressing quickly and continuously the channel adjustment button, when the intelligent TV no longer receives the DOWN event of the channel adjustment button within the predetermined first time period during a process of adjusting the displayed channel number by the presentation layer of the intelligent TV based on the instruction for channel adjustment, the intelligent TV invokes the intelligent TV channel switching interface to switch the current channel to the channel corresponding to the currently displayed channel number.

In a case where the channel adjustment button is click-pressed quickly and continuously, when the intelligent TV enters the quick channel switching process, the intelligent TV performs operations by referring to three aspects of operations of the above first trigger manner, which will not be repeated herein.

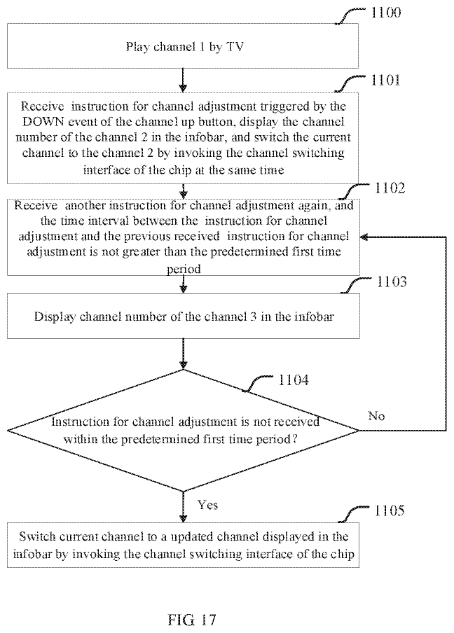

FIG. 17 is a schematic diagram of performing quick channel switching by click-pressing quickly and continuously a channel adjustment button according to some embodiments of the present disclosure. The following steps 1100-1105 are shown.

At step 1100, the TV plays the channel 1.

At step 1101, the instruction for channel adjustment triggered by the DOWN event of the channel up button is received, the information of the channel number of the channel 2 is displayed in the infobar of the display screen, and the current channel is switched to the channel 2 by invoking the channel switching interface of the chip at the same time.

At step 1102, another instruction for channel adjustment is received again, and the time interval between this instruction for channel adjustment and the previous instruction for channel adjustment is not greater than the predetermined first time period. Further, no UP event of the channel adjustment button is received between the adjacent instructions for channel adjustment.

At step 1103, a preset image is displayed on the display screen and the information of the channel number of the channel 3 is displayed in the infobar at the same time.

At step 1104, determining whether there is no instruction for channel adjustment received within the predetermined first time period, and in response to no instruction for channel adjustment received within the predetermined first time period, step 1105 is performed; and otherwise, step 1102 is performed.

At step 1105, the current channel is switched to the updated channel shown on the infobar by invoking the channel switching interface of the chip.

It is noted that, after step 1102, that is, upon receiving another instruction for channel adjustment and the time interval between the received instruction for channel adjustment and previous instruction for channel adjustment being not greater than the predetermined first time period, step 1103 is performed, the information output from the channel switching interface of the chip is shield, and channel switching performed by the channel switching interface of the chip is prohibited.

At step 1104, if it is determined there is no more instructions for channel adjustment received within the predetermined time period, step 1105 is performed, while the shielding of the information output from the channel switching interface is cancelled.

There is no strict timing for cancelling the shielding of the output information from the channel switching interface. The cancelling operation may be performed upon no instruction for channel adjustment being received within the predetermined first time period, or during a process of performing channel switching by invoking the intelligent TV channel switching interface.

It is noted that, in the above embodiments, after the first instruction for channel adjustment sent from the user through the remote control device is received for the first time and before the second instruction for channel adjustment sent from the user through the remote control device is no longer received within the predetermined first time period, the preset image is displayed on the display screen. The preset image is displayed in various manners, which will be described below by way of examples.

In the first display manner, a pre-stored image is displayed.

The preset image, for example, a blue screen image, is displayed according to pre-stored image content.

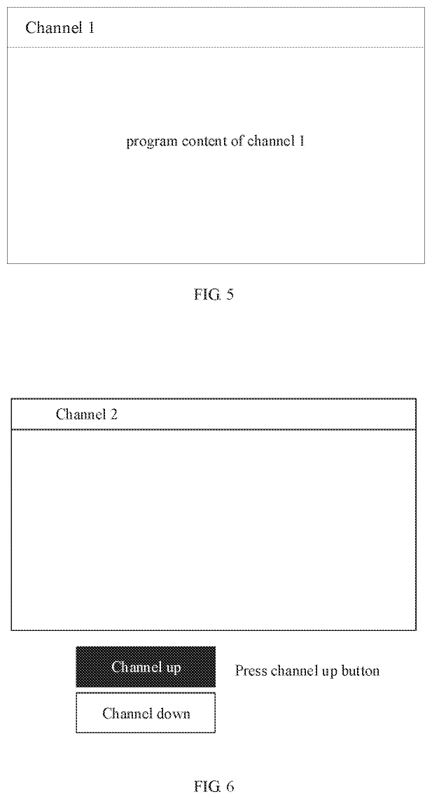

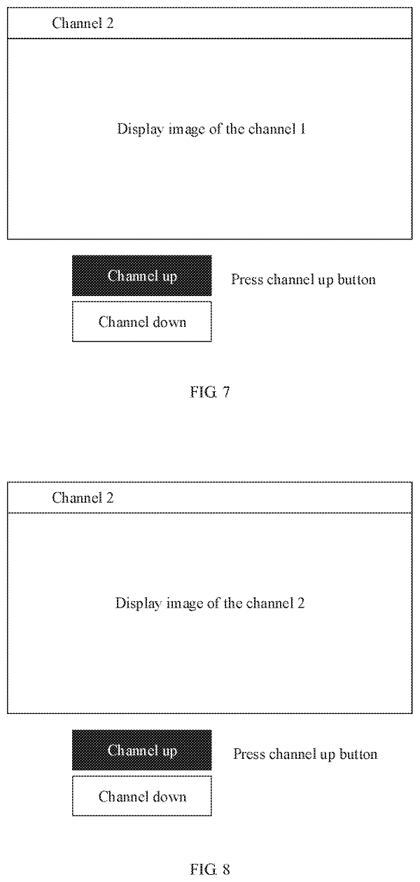

For example, a preset image according to some embodiments of the present disclosure is displayed as shown in FIG. 6.

It is assumed that the TV plays the channel 1 currently. When the channel up button of the remote controller is pressed, the TV receives the instruction for channel adjustment for adjusting channel up which is triggered by pressing the channel up button. And, the blue screen image is displayed on the display screen of the TV and the information of the channel number of the channel 2 is displayed in the infobar at the top of the display screen at the same time.

In the second display manner, a frame of image or an image frame played on a current channel is displayed.

For example, a preset image according to some embodiments of the present disclosure is displayed as shown in FIG. 7.

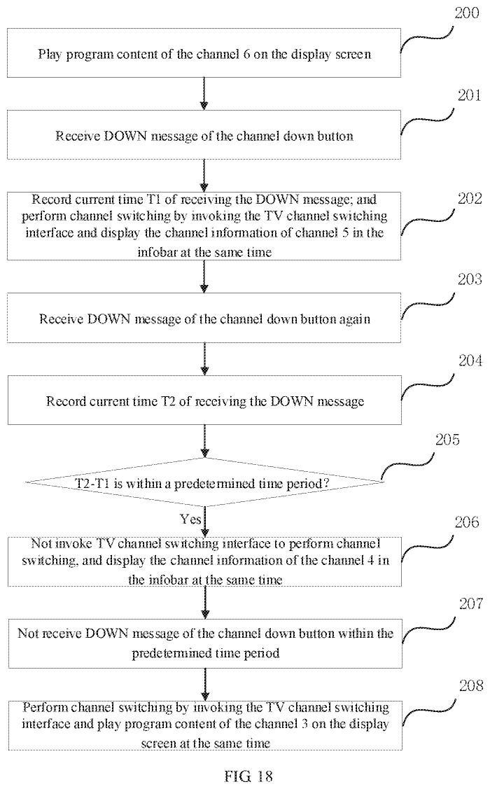

It is assumed the TV plays the channel 1 currently. When the channel up button of the remote controller is pressed, the TV receives the instruction for channel adjustment for adjusting channel up which is triggered by pressing the channel up button, the display screen of the TV displays the last frame of image played by the channel 1, and the information of the channel number of the channel 2 is displayed in the infobar at the top of the display screen at the same time. Detailed descriptions will be made below with reference to FIG. 18.

In the third display manner, optionally, a frame of image played by a channel corresponding to the updated channel number is displayed.

For example, a preset image according to some embodiments of the present disclosure is displayed as shown in FIG. 8.

It is assumed that the TV plays the channel 1 currently. When the channel up button of the remote controller is pressed, the TV receives the instruction for channel adjustment for adjusting channel up which is triggered by pressing the channel up button, and switches the channel 1 to the channel 2 by invoking the intelligent TV channel switching interface. And thereafter the TV will no longer invoke the intelligent TV channel switching interface for channel switching during a process of continuously adjusting the channel number displayed in the infobar. In this case, the display screen of the TV keeps displaying a particular frame of image played on the channel 2 until the instruction for channel adjustment is not received any longer.

FIG. 18 is another schematic diagram of performing quick channel switching by click-pressing quickly and continuously a channel adjustment button according to some embodiments of the present disclosure. The following steps 200 to 208 are shown. In order to adapt for user's watching habits, the displayed preset image is an image of a current channel displayed by the intelligent TV, that is, an image before starting channel adjustment. For example, a final frame of image of the channel 6 displayed immediately after the startup of the TV.

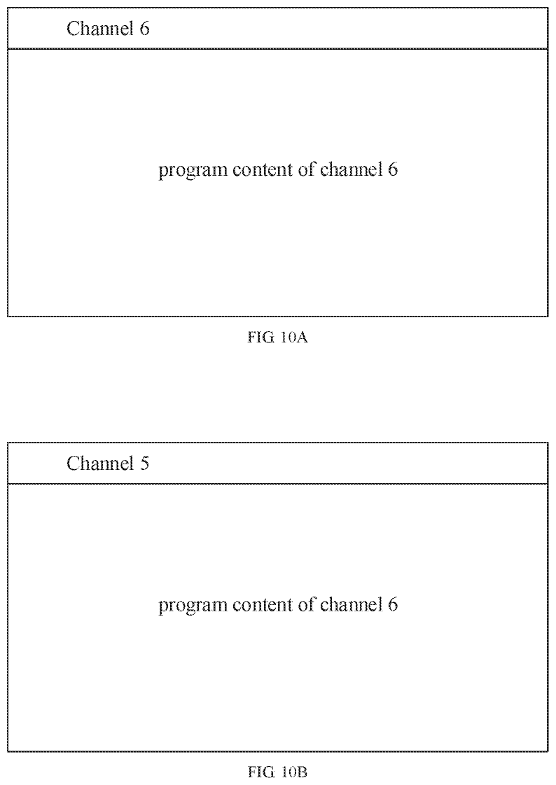

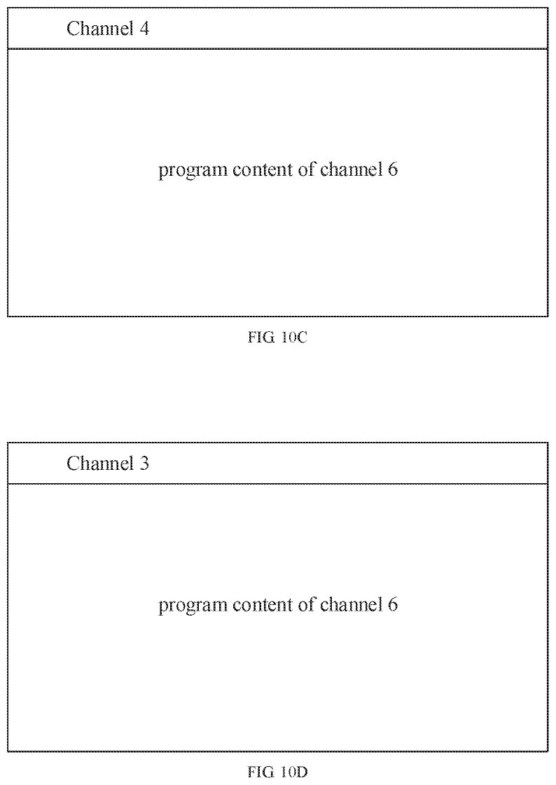

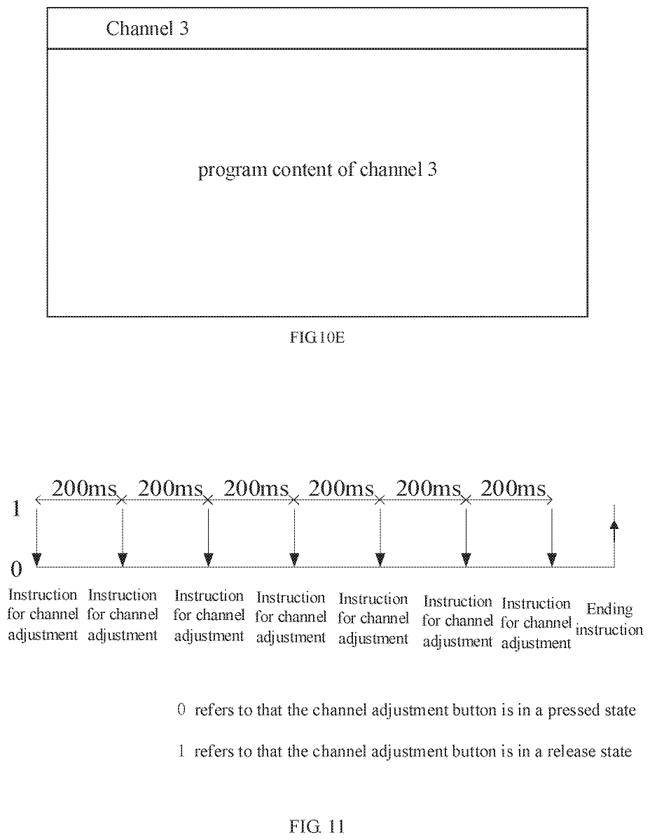

At step 200, program content of the channel 6 is played on the display screen. Herein, the user interface is as shown in FIG. 10A. As shown in FIG. 10A, the channel information such as channel name, the channel number and the like of the channel 6 is displayed in the infobar at the top of the display screen.

At step 201, the DOWN message of the channel down button is received from the remote control device.

At step 202, a current time T1 of receiving the DOWN message is recorded; and channel switching is performed by invoking the TV channel switching interface, and the channel information of channel 5 is displayed in the infobar of the display screen at the same time.

Herein, first, the current time T1, when the DOWN message of the channel down button is received, is recorded, so as to compare with the receive time of a following message.

Specifically, channel information of a channel with a smaller channel number, which is adjacent to the previous channel, is obtained from an existing channel list. For example, the channel information such as channel name, the channel number and the like of the channel 5 with the smaller channel number is displayed in the infobar, so that the user may see from the infobar that the TV already is triggered to perform channel switching.

At the same time, the DOWN message of the channel down button triggers the instruction for channel adjustment. In this case, a process of switching the channel 6 to the channel 5 is performed by invoking the channel switching interface of the chip, i.e. the TV channel switching interface. Because it takes a relatively long time to switch to channel 5 by invoking the TV chip, the TV chip will not successfully perform channel switching within a short time and the program content of the channel 6 is still displayed on the display screen in some embodiments. Herein, the user interface is as shown in FIG. 10B. In FIG. 10B, in order to quickly respond to the instruction for channel adjustment sent from the user through the remote control device and in order to notify the user that the TV already starts the process of switching to a next channel with the smaller channel number in time, channel information such as channel name, the channel number and the like of the next channel 5 to which the TV channel is to be switched, is displayed in the infobar at the top of the display screen.

At step 203, a DOWN message of the channel down button is received again from the remote control device.

At step 204, a current time T2 of receiving the DOWN message is recorded.

At step 205, it is determined whether T2-T1 (i.e. a difference between T2 and T1) is within a predetermined time period. If the difference is within the predetermined time period, step 206 is performed; and otherwise, the process is finished. Illustratively, the TV displays program content of the channel 5.

At step 206, the TV channel switching interface is no longer invoked to perform channel switching, and the channel information of the channel 4 is displayed in the infobar of the display screen at the same time.

The difference between the receive time T2 of receiving the second DOWN message and the receive time T1 of the first DOWN message is within the predetermined time period, which means the user intends to perform continuous channel switching within a short time. In this case, the TV is triggered to start the quick channel switching process.

Specifically, channel information of a channel with a smaller channel number, which is adjacent to the previous channel, is obtained from an existing channel list. For example, the channel information such as channel name, the channel number and the like of the channel 4 with the smaller channel number is displayed in the infobar, so that the user may be told from the infobar that the TV already is triggered to perform channel switching.

At the same time, all messages including the message of successfully switching the channel 6 to the channel 5, which are reported by the TV channel switching interface, are shielded to reduce the communications of the TV middleware.

Further, the TV channel switching interface is no longer invoked to perform channel switching, and the message of successfully switching the channel 6 to the channel 5 reported by the TV channel switching interface is shielded. Thus, the program content of the channel 6 is still displayed on the display screen. Herein, the user interface is as shown in FIG. 10C. As shown in FIG. 10C, in order to quickly respond to the instruction for channel adjustment sent from the user through the remote control device, and in order to notify the user that the TV already starts the process of switching to the channel 4 in time, channel information such as channel name, the channel number and the like of a next channel 4 with the smaller channel number to which the TV channel is to be switched, is displayed in the infobar at the top of the display screen.

It is noted that if the difference between a receive time T3 of the DOWN message of the channel down button and the receive time T2 of the previous DOWN message of the channel down button is within the predetermined time period, step 206 is performed. At the same time, for example, the displayed channel is switched from channel 4 to channel 3.

At step 207, no more DOWN message of the channel down button is received from the remote control device within the predetermined time period.

At step 208, channel switching is performed by invoking the TV channel switching interface and program content of the channel 3 is played on the display screen at the same time.

If no more DOWN message of the channel down button is received within the predetermined time period, which means the instruction for channel adjustment is no longer triggered. In this case, the quick channel switching process is stopped and the shielding of the message reported by the TV channel switching interface is cancelled at the same time. The channel information displayed finally in the infobar is transmitted to the TV chip, that is, the TV channel is switched to a channel corresponding to the channel information displayed finally in the infobar by invoking the TV channel switching interface.

For example, when the TV channel is switched to the channel 3 finally displayed in the infobar by invoking the TV channel switching interface, program content of the channel 3 is played on the display screen. Herein, the user interface is as shown in FIG. 10E. As shown in FIG. 10E, channel switching is performed by invoking the TV chip, and the TV channel is switched to the channel corresponding to the channel information displayed finally in the infobar. For example, program content of the channel 3 in the infobar shown in FIG. 10D is played on the display screen. The channel information such as channel name, the channel number and the like of the channel 3 is displayed in the infobar. In this case, the TV can display a channel that the user eventually wants to watch in time when the user no longer operates the remote control device, thereby avoiding a phenomenon that the TV is still switching channels or lagging.

Based on the same concept, the embodiments of the present disclosure further provide a device for switching channels. The device is an intelligent television (TV) performing the method of switching channels according to some embodiments of the present disclosure and the principle of solving the problems by the device is similar to that of the method. Therefore, the device may be implemented by referring to the implementation of the method, which will be omitted.

As shown in FIG. 19, the embodiments of the present disclosure provide an intelligent TV. The intelligent TV includes display screen, a processor 1200 and a memory 1201. The memory 1201 stores computer instructions. When one or more computer instructions stored in the memory 1201 are executed by the processor 1200, the intelligent TV is caused to perform any one of methods in FIG. 1, FIG. 12, FIG. 13, FIG. 17 and FIG. 18.

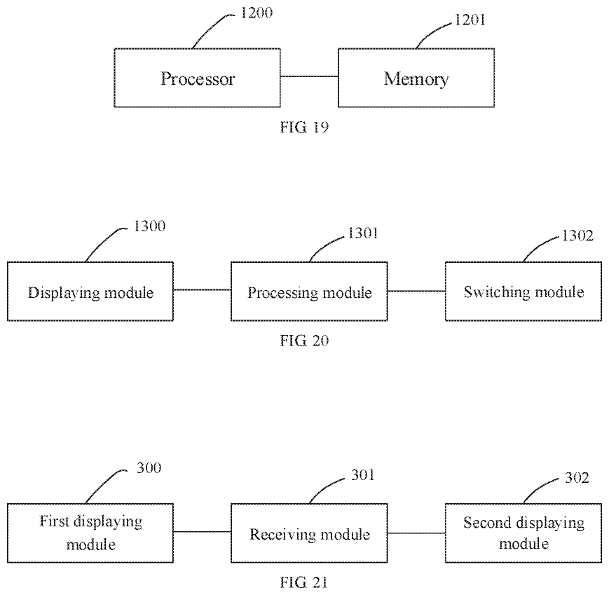

Based on the same concept, the embodiments of the present disclosure provide another intelligent TV as shown in FIG. 20. The intelligent TV includes a displaying module 1300, a processing module 1301 and a switching module 1302. The displaying module 1300 is configured to: while displaying a current channel, in response to receiving a first instruction for channel adjustment, display a first channel number based on the first instruction on a user interface displayed on a display screen of the intelligent TV. The processing module 1301 is configured to: determine an updated channel number by increasing or decreasing the first channel number based on a plurality of consecutive second instructions for channel adjustment without performing a channel switching operation, in response to receiving the plurality of consecutive second instructions for channel adjustment and determining that a time difference between two consecutive received instructions among the first instruction for channel adjustment and the plurality of consecutive second instructions for channel adjustment is less than or equal to a predetermined time period. The switching module 1302 is configured to: switch the current channel to a second channel corresponding to the updated channel number, in response to not receiving another second instruction for channel adjustment within the predetermined time period, or in response to determining that the predetermined time period has passed after receiving a last instruction of the plurality of consecutive second instructions for channel adjustment without receipt of another instruction for channel adjustment.

Optionally, the instruction for channel adjustment is triggered by receiving the DOWN event of the channel adjustment button of the remote control device.

In optional implementations, the processing module 1301 is specifically configured to: determine that the plurality of the second instructions for channel adjustment are triggered by a user long-pressing the channel adjustment button, in response to not receiving the UP event of the channel adjustment button between any two adjacent instructions of the first instruction and the plurality of the second instructions, or in response to determining that the first instruction and the plurality of consecutive second instructions were received prior to receiving any second event of the channel adjustment button; or determine that the plurality of the second instructions are triggered by the user click-pressing quickly and continuously the channel adjustment button, in response to receiving the second event of the channel adjustment button between any two consecutive received instructions of the first instruction and the plurality of the second instructions.

In optional implementations, the processing module 1301 is further configured to: switch the current channel to a first channel based on the first instruction for channel adjustment by invoking an intelligent TV channel switching interface, while the first channel number based on the first instruction for channel adjustment is displayed on a user interface displayed by a display screen of the intelligent TV, in response to the received first instruction for channel adjustment.

In optional implementations, the processing module 1301 is further configured to: display a preset image after displaying the first channel number in response to the received first instruction for channel adjustment and before the current channel is switched to the second channel by invoking the intelligent TV channel switching interface. The preset image includes a frame of image or an image frame played by the current channel, a frame of image played by the first channel based on the first instruction for channel adjustment received for the first time, or a pre-stored image.

In optional implementations, the processing module 1301 is further configured to: shield information output by the intelligent TV channel switching interface after the first channel number is displayed, in response to the received first instruction for channel adjustment.

In optional implementations, the processing module 1301 is further configured to: cancel the shielding of the information output by the intelligent TV channel switching interface, in response to switching the current channel to the second channel corresponding to the updated channel number by invoking the intelligent TV channel switching interface.

FIG. 21 shows a structure of another intelligent TV. As shown in FIG. 21, in optional implementations, the TV includes a first displaying module 300, a receiving module 301 and a second displaying module 302. The first displaying module 300 is configured to display program content of the current channel on the display screen. The receiving module 301 is configured to receive instructions of long-pressing the channel adjustment button from the remote control device. And a second displaying module 302 is configured to display a channel number increased or decreased by one in sequence in real time on the display screen when the receiving module 301 receives the instructions of long-pressing the channel adjustment button.

The receiving module 301 is further configured to receive an instruction of finishing long-pressing the channel adjustment button from the remote control device. The first displaying module 300 is further configured to directly switch to program content of the channel corresponding to the updated channel number on the display screen when the receiving module 301 receives the instruction of finishing long-pressing the channel adjustment button from the remote control device.

In other optional implementations, the TV includes a first displaying module 300, a receiving module 301 and a second displaying module 302. The first displaying module 300 is configured to display program content of the current channel on the display screen. The receiving module 301 is configured to receive instructions of continuously and quickly click-pressing the channel adjustment button from the remote control device. The second displaying module 302 is configured to display a channel number increased or decreased by one in sequence in real time on the display screen when the receiving module 301 receives the instructions of continuously and quickly click-pressing the channel adjustment button.

The receiving module 301 is further configured to receive an instruction of finishing continuous and quick click-pressing of the channel adjustment button from the remote control device. The first displaying module 300 is further configured to directly switch to program content of the channel corresponding to the updated channel number on the display screen when the receiving module 301 receives the instruction of finishing continuous and quick click-pressing of the channel adjustment button from the remote control device.

The embodiments of the present disclosure further provide a computer-readable non-volatile storage medium which stores computer instructions. The computer instructions are executed by a processor to: display a first channel number on a user interface displayed by a display screen of the intelligent television based on a first instruction for channel adjustment in response to receiving the first instruction for channel adjustment while displaying a current channel on the intelligent television; determine an updated channel number by increasing or decreasing the first channel number based on a plurality of consecutive second instructions for channel adjustment without performing a channel switching operation, in response to receiving the plurality of consecutive second instructions for channel adjustment and determining that a time difference between two consecutive received instructions of the first instruction for channel adjustment and the plurality of consecutive second instructions for channel adjustment is not greater than a predetermined time period; and switch the current channel to a second channel corresponding to the updated channel number, in response to not receiving another second instruction for channel adjustment within the predetermined time period, or determining that the predetermined time period has passed after receiving a last instruction of the plurality of consecutive second instructions for channel adjustment without receipt of another instruction for channel adjustment.

The above descriptions are made by referring to a block diagram and/or a flow chart of a method, an apparatus (system) and/or a computer program product according to the embodiments of the present disclosure. It is noted that one block or a combination of blocks of the block diagram and/or the flowchart may be implemented by computer program instructions. These computer program instructions may be provided to a processor of both a general-purpose computer and a dedicated computer, and/or another programmable data processing apparatus, so as to generate a machine. Therefore, instructions are executed by the computer processor and/or another programmable data processing apparatus to create a method of realizing functions/actions designated in a block of the block diagram and/or the flowchart.

Correspondingly, the present disclosure may also be implemented by hardware and/or software (including firmware, resident software and microcode and the like). Further, the present disclosure may be in the form of computer program products on a computer-usable or computer-readable storage medium, which have computer-usable or computer readable program codes realized in the medium for being used by an instruction execution system or in combination with the instruction execution system. In the context of the present disclosure, the computer usable or the computer-readable storage medium may be any medium which contains, stores, communicates, transmits or conveys programs, so as to be used by the instruction execution system, apparatus or device, or in combination with these instruction execution system, apparatus or device.

Apparently, those skilled in the art may make different modifications and variations to the present disclosure without departing from the spirit and scope of the present disclosure. If these modifications and variations of the present disclosure belong to the scope of the claims of the present disclosure and their equivalent technology, these modifications and variations shall fall within the scope of the present disclosure.

What is claimed is:

1. A method of switching channels for an intelligent television, the method comprising:
receiving a first instruction for channel adjustment by the intelligent television while displaying a current channel on a display screen of the intelligent television;
in response to receiving the first instruction for channel adjustment, displaying a first channel number based on the first instruction for channel adjustment on a user interface displayed by the display screen of the intelligent television;
receiving a plurality of consecutive second instructions for channel adjustment by the intelligent television;
determining that a time difference between two consecutive received instructions among the first instruction for channel adjustment and the plurality of consecutive second instructions for channel adjustment is less than or equal to a predetermined time period;
in response to receiving the plurality of consecutive second instructions for channel adjustment and in response to determining that the time difference between two consecutive received instructions among the first instruction for channel adjustment and the plurality of consecutive second instructions for channel adjustment is less than or equal to the predetermined time period, determining an updated channel number by increasing or decreasing a value of the first channel number based on the plurality of consecutive second instructions for channel adjustment without performing a channel switching operation;
determining that the predetermined time period has passed after receiving a last instruction of the plurality of consecutive second instructions for channel adjustment without receipt of another instruction for channel adjustment; and
in response to determining that the predetermined time period has passed after receiving a last instruction of the plurality of consecutive second instructions for channel adjustment without receipt of another instruction for channel adjustment, switching the current channel to a second channel corresponding to a value of the updated channel number.

2. The method according to claim 1, wherein the first instruction for channel adjustment and the plurality of consecutive second instructions for channel adjustment are triggered by a first event of a channel adjustment button of a remote control device, and the first event is a channel up event or a channel down event.

3. The method according to claim 2, further comprising:
determining that the first instruction and the plurality of consecutive second instructions were received prior to receiving any second event of the channel adjustment button, wherein the second event is a release event of the channel adjustment button; and
in response to determining that the first instruction and the plurality of consecutive second instructions were received prior to receiving any second event of the channel adjustment button, determining that the plurality of consecutive second instructions for channel adjustment were triggered by a user long-pressing the channel adjustment button.

4. The method according to claim 2, further comprising:
receiving, by the intelligent television, a second event of the channel adjustment button between any two consecutive received instructions of the first instruction and the plurality of consecutive second instructions, wherein the second event comprises a release event of the channel adjustment button; and
in response to receiving the second event of the channel adjustment button between any two consecutive received instructions of the first instruction and the plurality of consecutive second instructions, determining that the plurality of consecutive second instructions for channel adjustment were triggered by a user click-pressing the channel adjustment button.

5. The method according to claim 1, wherein said determining an updated channel number by increasing or decreasing a value of the first channel number based on the plurality of consecutive second instructions for channel adjustment without performing a channel switching operation further comprises:
shielding information output from an intelligent television channel switching interface;
suspending channel switching that is performed by invoking the intelligent television channel switching interface; and
updating a channel number displayed on the display screen of the intelligent television based on the plurality of consecutive second instructions for channel adjustment.

6. The method according to claim 3, further comprising:
in a scenario where the plurality of the consecutive second instructions for channel adjustment are triggered by long-pressing the channel adjustment button, receiving a plurality of DOWN messages of the channel adjustment button of the remote control device continuously, and other DOWN messages in the plurality of DOWN messages except for a first DOWN message corresponding to the first instruction for channel adjustment, carry repeat fields; and
receiving an UP message of the channel adjustment button of the remote control device.

7. The method according to claim 4, further comprising:
in a scenario where the plurality of the consecutive second instructions for channel adjustment are triggered by click-pressing the channel adjustment button, receiving a plurality of DOWN messages of the channel adjustment button on the remote control device continuously, and a time difference between adjacent two of the plurality of DOWN messages is less than or equal to the predetermined time period; and
receiving no DOWN message of the channel adjustment button within the predetermined time period.

8. The method according to claim 1, further comprising:
switching the current channel to a first channel based on the first instruction for channel adjustment by invoking an intelligent television channel switching interface.

9. The method according to claim 8, further comprising:
after the first channel number is displayed in response to the first instruction for channel adjustment, and before the current channel is switched to the second channel corresponding to the updated channel number,
displaying a preset image comprising an image frame played on the first channel.

10. The method according to claim 5, further comprising:
after the current channel is switched to the second channel,
cancelling the shielding of the information output by the intelligent television channel switching interface.

11. An intelligent television, comprising:
a display screen;
a memory, configured to store computer instructions, and
a processor, configured to execute the computer instructions to cause the intelligent television to:
receive a first instruction for channel adjustment while displaying a current channel on the display screen;
in response to receiving the first instruction for channel adjustment, display a first channel number based on the first instruction for channel adjustment on a user interface displayed on the display screen;
receive a plurality of consecutive second instructions for channel adjustment;
determine that a time difference between two consecutive received instructions among the first instruction and the plurality of consecutive second instructions is less than or equal to a predetermined time period;
in response to receiving the plurality of consecutive second instructions and in response to determining that the time difference between two consecutive received instructions among the first instruction and the plurality of consecutive second instructions is less than or equal to the predetermined time period, determine an updated channel number by increasing or decreasing a value of the first channel number based on the plurality of consecutive second instructions for channel adjustment without performing a channel switching operation;
determine that the predetermined time period has passed after receiving a last instruction of the plurality of consecutive second instructions for channel adjustment without receipt of another instruction for channel adjustment; and
in response to determining that the predetermined time period has passed after receiving a last instruction of the plurality of consecutive second instructions for channel adjustment without receipt of another instruction for channel adjustment, switch the current channel to a second channel corresponding to a value of the updated channel number.

12. The intelligent television according to claim 11, wherein the first instruction for channel adjustment and the plurality of consecutive second instructions for channel adjustment are triggered by a first event of a channel adjustment button of a remote control device, and the first event is a channel up event or a channel down event.

13. The intelligent television according to claim 12, wherein the processor is further configured to execute the computer instructions to cause the intelligent television to:
determine that the first instruction and the plurality of consecutive second instructions were received prior to receiving any second event of the channel adjustment button, wherein the second event is a release event of the channel adjustment button; and
in response to determining that the first instruction and the plurality of consecutive second instructions were received prior to receiving any second event of the channel adjustment button, determine that the plurality of consecutive second instructions for channel adjustment were triggered by a user long-pressing the channel adjustment button.

14. The intelligent television according to claim 12, wherein the processor is further configured to execute the computer instructions to cause the intelligent television to:
receive a second event of the channel adjustment button between any two consecutive received instructions of the first instruction and the plurality of consecutive second instructions, wherein the second event comprises a release event of the channel adjustment button; and
in response to receiving the second event of the channel adjustment button between any two consecutive received instructions of the first instruction and the plurality of consecutive second instructions, determine that the plurality of consecutive second instructions for channel adjustment were triggered by a user click-pressing the channel adjustment button.

15. The intelligent television according to claim 11, wherein the processor is further configured to execute the computer instructions to cause the intelligent television to:
shield information output from an intelligent television channel switching interface;
suspend channel switching that is performed by invoking the intelligent television channel switching interface; and
updating a channel number displayed on the display screen based on the plurality of consecutive second instructions for channel adjustment.

16. The intelligent television according to claim 11, wherein the processor is further configured to execute the computer instructions to cause the intelligent television to:
switch the current channel to a first channel based on the first instruction for channel adjustment by invoking an intelligent television channel switching interface.

17. The intelligent television according to claim 16, wherein the processor is further configured to execute the computer instructions to cause the intelligent television to:
display a preset image comprising an image frame played on the first channel.

18. A computer-readable non-volatile storage medium storing computer instructions, wherein the computer instructions are executed by a processor to:
receive a first instruction for channel adjustment while displaying a current channel on an intelligent television;
in response to receiving the first instruction for channel adjustment, display a first channel number based on the first instruction for channel adjustment on a user interface displayed by a display screen of the intelligent television;
receive a plurality of consecutive second instructions for channel adjustment;
determine that a time difference between two consecutive received instructions among the first instruction and the plurality of consecutive second instructions is less than or equal to a predetermined time period;
in response to receiving the plurality of consecutive second instructions and in response to determining that the time difference between two consecutive received instructions among the first instruction and the plurality of consecutive second instructions is less than or equal to the predetermined time period, determine an updated channel number by increasing or decreasing a value of the first channel number based on the plurality of consecutive second instructions for channel adjustment without performing a channel switching operation;
determine that the predetermined time period has passed after receiving a last instruction of the plurality of consecutive second instructions for channel adjustment without receipt of another instruction for channel adjustment; and
in response to determining that the predetermined time period has passed after receiving a last instruction of the plurality of consecutive second instructions for channel adjustment without receipt of another instruction for channel adjustment, switch the current channel to a second channel corresponding to a value of the updated channel number.
